(19) United States
(12) Patent Application Publication
(10) Pub. No.: US 2015/0364115 A1
(43) Pub. Date: Dec. 17, 2015

(54) APPARATUS AND METHOD FOR ADAPTIVE LIGHT MODULATOR TRANSITION DELAY COMPENSATION

(71) Applicant: Pixtronix, Inc., San Diego, CA (US)

(72) Inventor: Fahri Yaras, Chelsea, MA (US)

(21) Appl. No.: 14/303,432

(22) Filed: Jun. 12, 2014

(51) Int. Cl. G09G 5/18

(52) U.S. Cl. CPC G09G 5/18

(57) ABSTRACT

This disclosure provides systems, methods and apparatus, including computer programs encoded on computer storage media, for compensating for slow light modulator transitions in a display device due to opposing motion events. In an opposing motion event, portions of respective pairs of neighboring light modulators are to be driven in opposite directions simultaneously. In one aspect, a controller associated with the display device can be configured to determine light modulator transitions associated with displaying an image frame based on at least two subframes associated with the image frame. The controller can identify one or more opposing motion events based on the determined light modulator transitions. The controller can obtain an output sequence parameter for displaying the image frame based on the identified one or more motion events, and cause the image frame to be displayed according to the obtained output sequence.

### TECHNICAL FIELD

This disclosure relates to the field of displays, and in particular, to image formation processes used by displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

EMS-based display devices have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus including a plurality of light modulators and a controller. The controller is configured to determine light modulator transitions associated with displaying an image frame based on at least two subframes associated with the image frame. Based on the determined light modulator transitions, the controller identifies one or more opposing motion events in which portions of respective pairs of neighboring light modulators are to be driven in opposite directions substantially simultaneously. The controller can obtain an output sequence parameter for displaying the image frame based on the identified one or more motion events and cause the image frame to be displayed according to the obtained output sequence parameter.

In some implementations, an opposing motion event can include portions of a respective pair of neighboring light modulators moving toward each other or away from each other in opposite directions substantially simultaneously. In some implementations, an opposing motion event can occur within a respective pair of neighboring light modulators with portions of one light modulator remaining still while portions of the other light modulator moving toward or away from the still portions. In some implementations, in identifying the one or more opposing motion events, the controller can be configured to determine a number of opposing motion events associated with displaying a region of the image frame and compare the number of opposing motion events to a threshold value. The controller can obtain the output sequence parameter based on the identified one or more motion events upon determining that the number of opposing motion events is larger than or equal to the threshold value. In some implementations, in identifying the one or more opposing motion events, the controller can identify a cluster of opposing motion events associated with displaying a region of the image frame. The controller can obtain the output sequence parameter based on the identified cluster of opposing motion events.

In some implementations, the controller can adjust, in obtaining the output sequence parameter, a voltage level based on the identified one or more opposing motion events. The adjusted voltage level is indicated in the output sequence to be applied to a corresponding light modulator of the plurality of light modulators. In some implementations, the controller can adjust, in obtaining the output sequence parameter, an illumination intensity based on the identified one or more opposing motion events. The adjusted illumination intensity is indicated in the output sequence to be applied to a light source associated with at least one light modulator of the plurality of light modulators. In some implementations, the controller can adjust, in obtaining the output sequence parameter, a time duration based on the identified one or more opposing motion events. The time duration is the time duration between initiating actuation of light modulators and turning on an illumination light. In some implementations, the controller can adjust, in obtaining the output sequence parameter, a number of subframes used to display the image frame based on the identified one or more opposing motion events.

In some implementations, the apparatus can further include a display including the plurality of light modulators, a processor capable of communicating with the display, the processor being capable of processing image frame data, and a memory device capable of communicating with the processor. In some implementations, the apparatus can further include a driver circuit capable of sending at least one signal to the display, the controller being capable of sending at least a portion of the image frame data to the driver circuit. In some implementations, the apparatus can further include an image source module capable of sending the image frame data to the processor. The image source module can include a receiver, transceiver, and/or transmitter. In some implementations, the apparatus can further include an input device capable of receiving input data and communicating the input data to the processor.

Another innovative aspect of the subject matter described in this disclosure can be implemented in a computer readable medium including computer code instructions stored thereon. When executed by a controller, the computer code instructions determine light modulator transitions associated with displaying an image frame based on at least two subframes associated with the image frame. Based on the determined light modulator transitions, the executed computer code instructions identify one or more opposing motion events in which portions of respective pairs of neighboring light modulators are to be driven in opposite directions substantially simultaneously. The executed computer code instructions can obtain an output sequence parameter for displaying the image frame based on the identified one or more motion events and can cause the image frame to be displayed according to the obtained output sequence parameter.

In some implementations, an opposing motion event can include portions of a respective pair of neighboring light modulators moving toward each other or away from each other in opposite directions, substantially simultaneously. In some implementations, an opposing motion event can occur within a respective pair of neighboring light modulators with portions of one light modulator remaining still while portions of the other light modulator moving toward or away from the still portions. In some implementations, identifying the one or more opposing motion events can include determining a number of opposing motion events associated with displaying a region of the image frame and comparing the number of opposing motion events to a threshold value. The computer code instructions can obtain the output sequence parameter based on the identified one or more motion events upon determining that the number of opposing motion events is larger than or equal to the threshold value. In some implementations, identifying the one or more opposing motion events can include identifying a cluster of opposing motion events associated with displaying a region of the image frame. The computer code instructions can obtain the output sequence parameter based on the identified cluster of opposing motion events.

In some implementations, obtaining the output sequence parameter can include adjusting a voltage level based on the identified one or more opposing motion events. The voltage level can be indicated in the output sequence to be applied to a corresponding light modulator of the plurality of light modulators. In some implementations, obtaining the output sequence parameter can include adjusting an illumination intensity based on the identified one or more opposing motion events. The illumination intensity can be indicated in the output sequence to be applied to a light source associated with at least one light modulator of the plurality of light modulators. In some implementations, obtaining the output sequence parameter can include adjusting a time duration based on the identified one or more opposing motion events. The time duration can represent the time duration between initiating actuation of light modulators and turning on an illumination light. In some implementations, obtaining the output sequence parameter can include adjusting a number of subframes used to display the image frame based on the identified one or more opposing motion events.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows a cross sectional view of an example display apparatus incorporating shutter-based light modulators.

FIG. 4 shows a block diagram of an example display apparatus.

FIG. 5 shows a block diagram of example control logic suitable for use in the display apparatus shown in FIG. 4.

FIGS. 6A and 6B show example opposing motion events for two adjacent shutter assemblies.

FIG. 7 shows example state transitions and corresponding shutter-motion patterns associated with an example set of subframes for two adjacent light modulators.

FIG. 8 shows a truth table for example logic for identifying opposing motion events.

FIG. 9A shows a flow diagram of an example method of displaying an image frame.

FIG. 9B shows a flow diagram of another example method of displaying an image frame.

FIGS. 10A and 10B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Many display devices include display elements that modulate light by selectively moving a light blocking component into and out of an optical path through an aperture defined through a light blocking layer. In some implementations, the light blocking elements are immersed in and surrounded by a fluid. The fluid can be a liquid, a gas, or a combination thereof. In cases where a pair of light blocking elements associated with two adjacent light modulators are driven to move towards each other or away from each other in opposite directions (referred to herein as “opposing motion events”), an increase or, respectively, a decrease in fluid pressure between the light blocking elements slows the motion of the light blocking elements. The slower motion of the light blocking elements results in longer transition periods for the light modulators. If ignored, such longer transition times can reduce image quality as the display backlight may be illuminated before the light blocking elements are in the desired positions, allowing more or less light to be emitted through impacted display elements than desired.

A controller of a display device can monitor for and adjust its operations based on the detection of opposing motion events. The controller can identify the presence of opposing motion events by evaluating entire image frames holistically, or by comparing an image subframe to be loaded into the display elements of the display with the current state of the display elements. Upon identifying a problematic level of opposing motion events, the controller can take steps to mitigate the potential for image quality degradation. The controller can deem a detected set of opposing motion events as problematic if, for example, the set includes more than an absolute threshold number of opposing motion events or if the set includes a subset of opposing motion events that are sufficiently large in number and spatially close to one another to be likely to be perceivable by the human visual system (“HVS”).

In general, the controller mitigates the image degradation risks of opposing motion events by altering one or more parameters of an output sequence that governs the addressing, actuation, and illumination of the display elements to display an image frame or a given image subframe. For example, in some implementations, the controller can increase an actuation voltage applied to the display elements such that the force provided by display element actuators that move the light blocking elements in the display elements is increased to counter the resistance provided by the fluid pressure variation. In some other implementations, the controller accepts the slower motion of the light blocking elements, delaying the illumination of the backlight until the light blocking elements have obtained their desired states at their slower speeds. In such implementations, the controller may cause the backlight to be illuminated for a shorter duration for a subframe at increased intensity. In some other of such implementations, if the delay introduced by allowing the light blocking elements to transition at a slower speed exceeds a threshold, the controller may reduce the number of subframes used to display an image frame. In some implementations, the controller may alter both the actuation voltage applied as well as adjust other parameters of the output sequence.

Particular implementations of the subject matter described in this disclosure can be implemented to realize one or more of the following potential advantages. In general, the image formation apparatus and processes disclosed herein mitigate the risk of image quality degradation caused due to slower motion of light blocking elements in display elements that can result from opposing motion events. The apparatus and methods can either counter the forces associated with the opposing motion events by increasing display element actuation voltages or they can mitigate the impact of the slower motion by adjusting other display output sequence parameters.

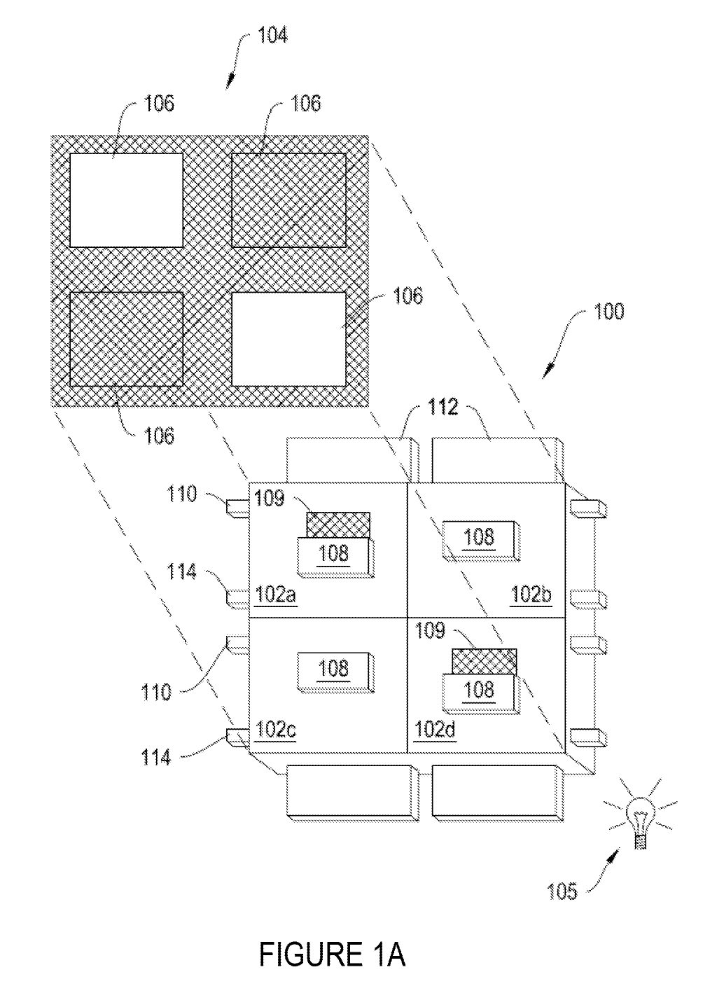

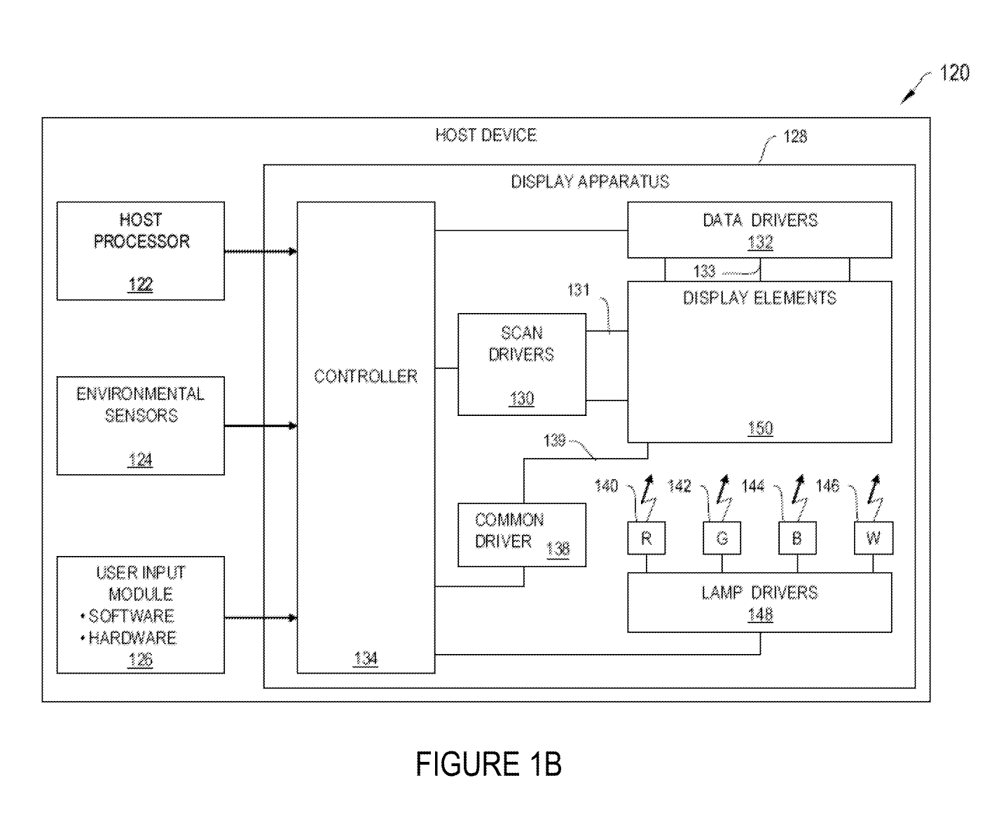

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiple rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying only a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for only a certain fraction of the image is loaded to the array of display elements 150. For example, the sequence can be implemented to address only every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

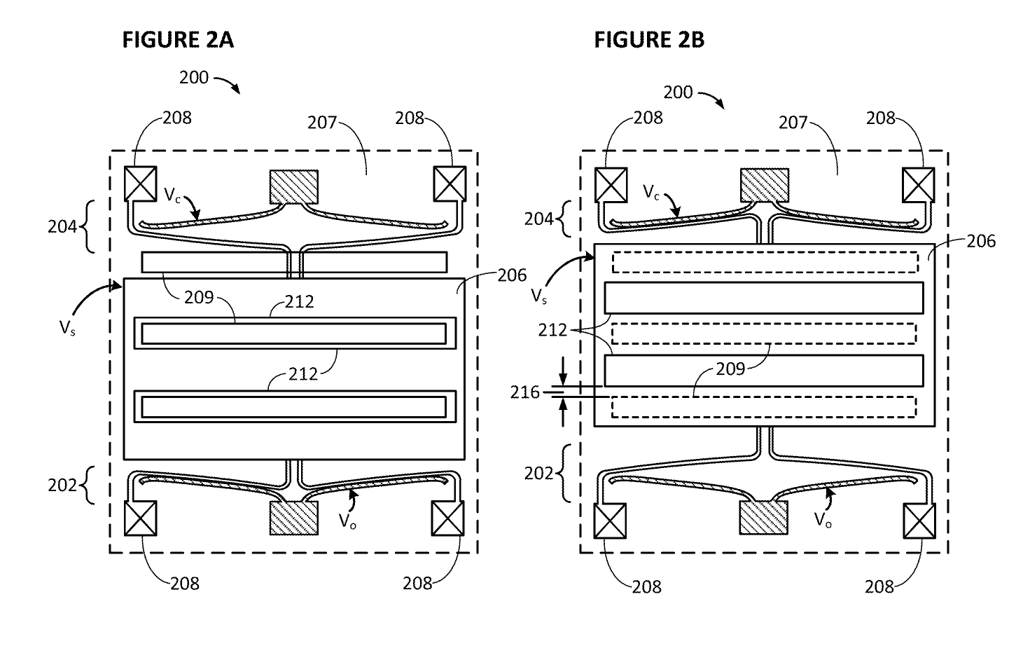

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have only a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

Electrical bi-stability in electrostatic actuators, such as actuators 202 and 204, can arise from the fact that the electrostatic force across an actuator is a function of position as well as voltage. The beams of the actuators in the shutter assembly 200 can be implemented to act as capacitor plates. The force between capacitor plates is proportional to 1/d² where d is the local separation distance between capacitor plates. When the actuator is in a closed state, the local separation between the actuator beams is very small. Thus, the application of a small voltage can result in a relatively strong force between the actuator beams of the actuator in the closed state. As a result, a relatively small voltage, such as Vₘ, can keep the actuator in the closed state, even if other elements exert an opposing force on the actuator.

In dual-actuator light modulators, the equilibrium position of the light modulator can be determined by the combined effect of the voltage differences across each of the actuators. In other words, the electrical potentials of the three terminals, namely, the shutter open drive beam, the shutter close drive beam, and the load beams, as well as modulator position, can be considered to determine the equilibrium forces on the modulator.

For an electrically bi-stable system, a set of logic rules can describe the stable states and can be used to develop reliable addressing or digital control schemes for a given light modulator. Referring to the shutter assembly 200 as an example, these logic rules are as follows:

Let Vₛ be the electrical potential on the shutter or load beam. Let Vₒ be the electrical potential on the shutter-open drive beam. Let V_{c} be the electrical potential on the shutter-close drive beam. Let the expression |Vₒ−Vₛ| refer to the absolute value of the voltage difference between the shutter and the shutter-open drive beam. Let Vₘ be the maintenance voltage. Let Vₐₜ be the actuation threshold voltage, i.e., the voltage to actuate an actuator absent the application of Vₘ to an opposing drive beam. Let Vₘₐₓ be the maximum allowable potential for Vₒ and V_{c}. Let Vₘ<Vₐₜ<Vₘₐₓ. Then, assuming Vₒ and V_{c} remain below Vₘₐₓ:

If |Vₒ−Vₛ|<Vₘ and |V_{c}−Vₛ|<Vₘ (rule 1)

Then the shutter will relax to the equilibrium position of its mechanical spring.

If |Vₒ−Vₛ|>Vₘ and |V_{c}−Vₛ|>Vₘ (rule 2)

Then the shutter will not move, i.e., it will hold in either the open or the closed state, whichever position was established by the last actuation event.

If |Vₒ−Vₛ|>Vₐₜ and |V_{c}−Vₛ|<Vₘ (rule 3)

Then the shutter will move into the open position.

If |Vₒ−Vₛ|<Vₘ and |V_{c}−Vₛ|>Vₐₜ (rule 4)

Then the shutter will move into the closed position.

Following rule 1, with voltage differences on each actuator near zero, the shutter will relax. In many shutter assemblies, the mechanically relaxed position is only partially open or closed, and so this voltage condition is usually avoided in an addressing scheme.

The condition of rule 2 makes it possible to include a global actuation function into an addressing scheme. By maintaining a shutter voltage which provides beam voltage differences that are at least the maintenance voltage, Vₘ, the absolute values of the shutter open and shutter closed potentials can be altered or switched in the midst of an addressing sequence over wide voltage ranges (even where voltage differences exceed Vₐₜ) with no danger of unintentional shutter motion.

The conditions of rules 3 and 4 are those that are generally targeted during the addressing sequence to ensure the bi-stable actuation of the shutter.

The maintenance voltage difference, Vₘ, can be designed or expressed as a certain fraction of the actuation threshold voltage, Vₐₜ. For systems designed for a useful degree of bi-stability, the maintenance voltage can exist in a range between about 20% and about 80% of Vₐₜ. This helps ensure that charge leakage or parasitic voltage fluctuations in the system do not result in a deviation of a set holding voltage out of its maintenance range—a deviation which could result in the unintentional actuation of a shutter. In some systems, an exceptional degree of bi-stability or hysteresis can be provided, with Vₘ existing over a range of about 2% and about 98% of Vₐₜ. In these systems, however, care should be taken to ensure that an electrode voltage condition of |V_{c}−Vₛ| or |V₀−Vₛ| being less than Vₘ can be reliably obtained within the addressing and actuation time available.

In some implementations, the first and second actuators of each light modulator are coupled to a latch or a drive circuit to ensure that the first and second states of the light modulator are the only two stable states that the light modulator can assume.

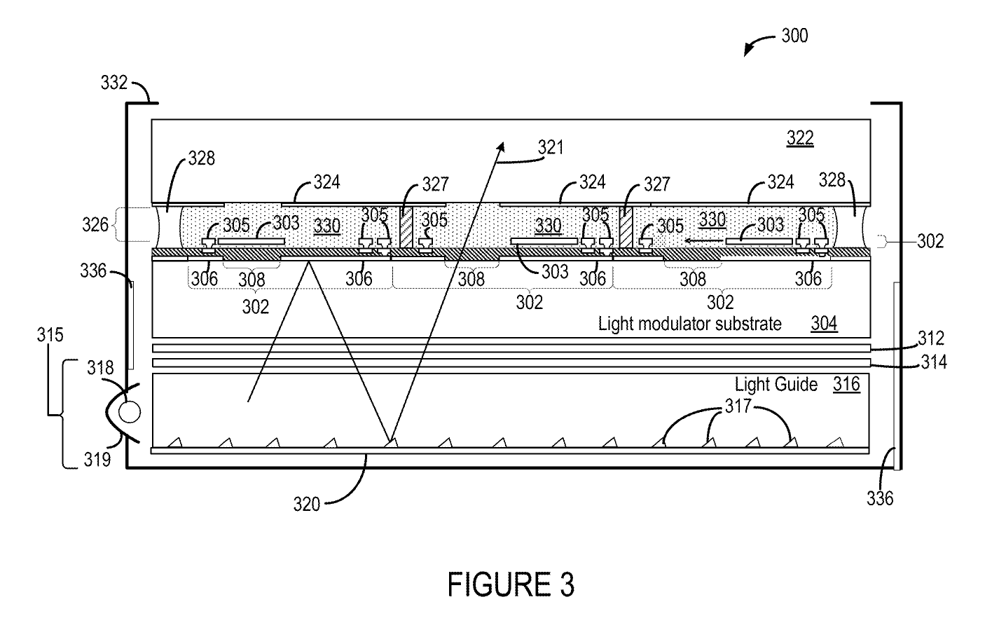

FIG. 3 shows a cross sectional view of an example display apparatus 300 incorporating shutter-based light modulators. As shown, the shutter based light modulators take the form of shutter assemblies 302, similar to the shutter assemblies 200 shown in FIGS. 2A and 2B. Each shutter assembly 302 incorporates a shutter 303 and anchors 305. Not shown are the compliant beam actuators which, when connected between the anchors 305 and the shutters 303, help to suspend the shutters 303 a short distance above the surface. The shutter assemblies 302 are disposed on a transparent substrate 304, such as a substrate made of plastic or glass. A rear-facing reflective layer, reflective film 306, disposed on the substrate 304 defines a plurality of surface apertures 308 located beneath the closed positions of the shutters 303 of the shutter assemblies 302. The reflective film 306 reflects light not passing through the surface apertures 308 back towards the rear of the display apparatus 300.

The display apparatus 300 includes an optional diffuser 312 and/or an optional brightness enhancing film 314 which separate the substrate 304 from a planar light guide 316. The light guide 316 includes a transparent material, such as glass or plastic. The light guide 316 is illuminated by one or more light sources 318. The light guide 316, together with the light sources 318 form a backlight. The light sources 318 can be, for example, and without limitation, incandescent lamps, fluorescent lamps, lasers or light emitting diodes (LEDs). A reflector 319 helps direct light from the light sources 318 towards the light guide 316. A front-facing reflective film 320 is disposed behind the light guide 316, reflecting light towards the shutter assemblies 302.

The light guide 316 includes a set of geometric light redirectors or prisms 317 which re-direct light from the light sources 318 towards the surface apertures 308 and hence toward the front of the display 300. The light redirectors 317 can be molded into the plastic body of light guide 316 with shapes that can be alternately triangular, trapezoidal, or curved in cross section. The density of the prisms 317 generally increases with distance from the light source 318.

A cover plate 322 forms the front of the display apparatus 300. The rear side of the cover plate 322 can be covered with a patterned light blocking layer 324 to increase contrast. The cover plate 322 is supported a predetermined distance away from the shutter assemblies 302 forming a cell gap 326. The cell gap 326 is maintained by mechanical supports or spacers 327 and/or by an adhesive seal 328 attaching the cover plate 322 to the substrate 304.

The adhesive seal 328 seals in a fluid 330. The fluid 330 can have a low coefficient of friction, low viscosity, and minimal degradation effects over the long term. The fluid immerses and surrounds the moving parts of the shutter assemblies 302, and can serve as a lubricant. In some implementations, the fluid 330 is a hydrophobic liquid with a high surface wetting capability. In some implementations, the fluid 330 has a refractive index that is either greater than or less than that of the substrate 304. In some implementations, in order to reduce the actuation voltages, the fluid 330 has a viscosity below about 70 centipoise. In some other implementations, the liquid has a viscosity below about 10 centipoise. Liquids with viscosities below 70 centipoise can include materials with low molecular weights: below 4000 grams/mole, or in some cases below 400 grams/mole. Fluids that may be suitable as the fluid 330 include, without limitation, de-ionized water, methanol, ethanol and other alcohols, paraffins, olefins, ethers, silicone oils, fluorinated silicone oils, or other natural or synthetic solvents or lubricants. Useful fluids also can include polydimethylsiloxanes (PDMS), such as hexamethyldisiloxane and octamethyltrisiloxane, or alkyl methyl siloxanes such as hexylpentamethyldisiloxane. Additional useful fluids include alkanes, such as octane or decane, nitroalkanes, such as nitromethane, and aromatic compounds, such as toluene or diethylbenzene. Further useful fluids include ketones, such as butanone or methyl isobutyl ketone, chlorocarbons, such as chlorobenzene, and chlorofluorocarbons, such as dichlorofluoroethane or chlorotrifluoroethylene. Other suitable fluids include butyl acetate, dimethylformamide, hydro fluoro ethers, perfluoropolyethers, hydro fluoro poly ethers, pentanol, and butanol. Example suitable hydro fluoro ethers include ethyl nonafluorobutyl ether and 2-trifluoromethyl-3-ethoxydodecafluorohexane.

Referring back to FIG. 3, a sheet metal or molded plastic assembly bracket 332 holds the cover plate 322, the substrate 304, the backlight and the other component parts of the display apparatus 300 together around the edges. The assembly bracket 332 is fastened with screws or indent tabs to add rigidity to the combined display apparatus 300. In some implementations, the light source 318 is molded in place by an epoxy potting compound. Reflectors 336 help return light escaping from the edges of the light guide 316 back into the light guide 316. Not depicted in FIG. 3 are electrical interconnects which provide control signals as well as power to the shutter assemblies 302 and the lamps 318.

The display apparatus 300 is referred to as the MEMS-up configuration, where the MEMS-based light modulators are formed on a front surface of the substrate 304, i.e., the surface that faces toward the viewer. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to in this configuration as the aperture plate. In the MEMS-down configuration, the substrate that carries the MEMS-based light modulators takes the place of the cover plate 322 in the display apparatus 300 and is oriented such that the MEMS-based light modulators are positioned on the rear surface of this top substrate, i.e., the surface that faces away from a viewer and toward the light guide 316.

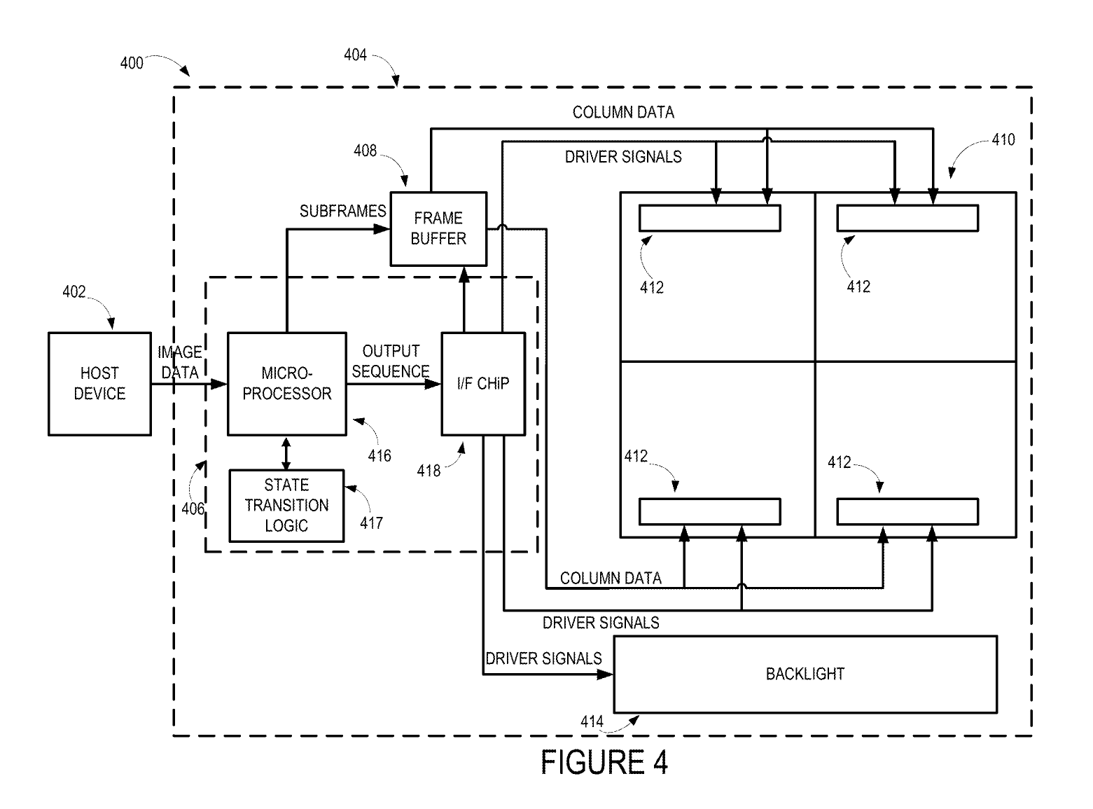

FIG. 4 shows a block diagram of an example display apparatus 400. The display apparatus 400 includes a host device 402 and a display module 404. The host device can be any of a number of electronic devices, such as a portable telephone, a smartphone, a watch, a tablet computer, a laptop computer, a desktop computer, a television, a set top box, a DVD or other media player, or any other device that provides graphical output to a display. In general, the host device 402 serves as a source for image data to be displayed on the display module 404.

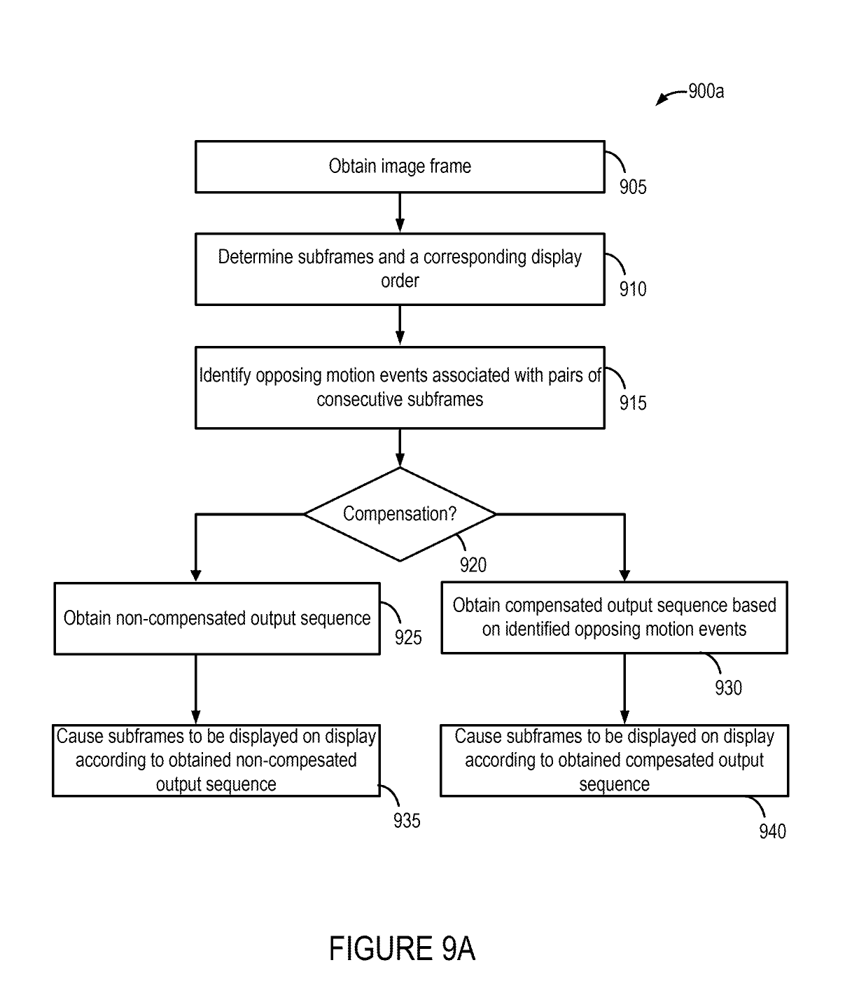

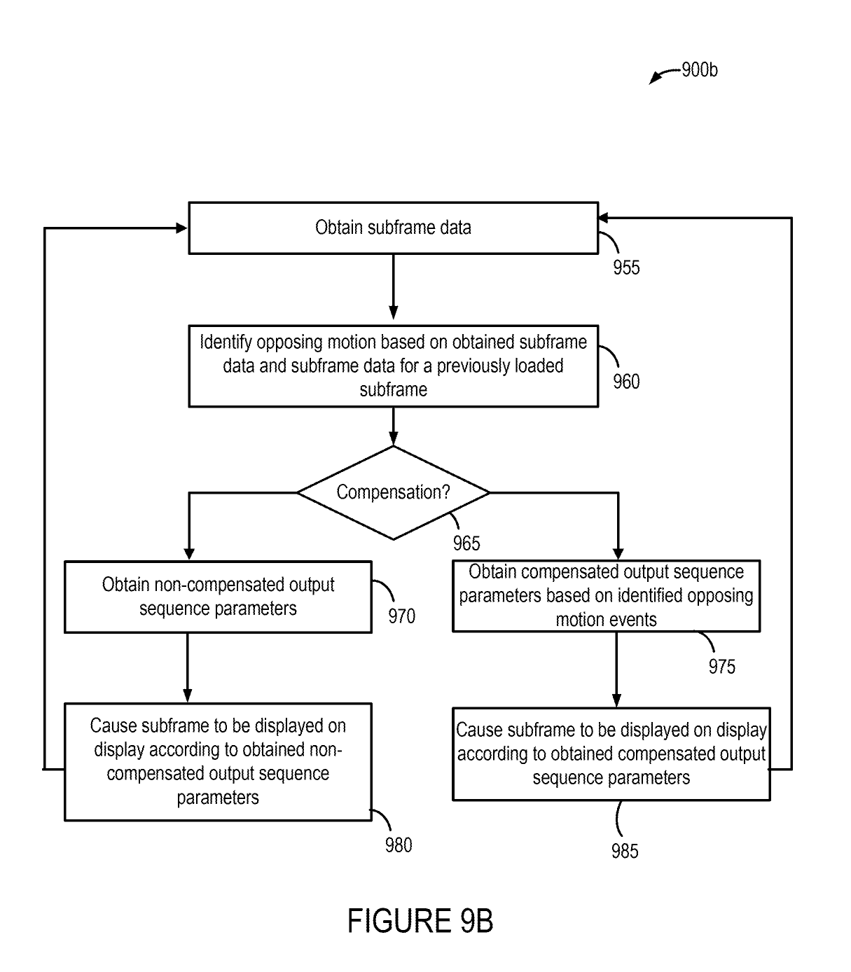

The display module 404 further includes control logic 406, a frame buffer 408, an array of display elements 410, display drivers 412 and a backlight 414. The control logic 406 can serve to process image data received from the host device 402 and controls the display drivers 412, array of display elements 410 and backlight 414 to together produce the images encoded in the image data. The functionality of the control logic 406 is described further below in relation to FIGS. 9A and 9B.

In some implementations, as shown in FIG. 4, the functionality of the control logic 406 is divided between a microprocessor 416 and an interface (I/F) chip 418. The control logic 406 can further include a state transition logic 417. In some implementations, the interface chip 418 is implemented in an integrated circuit logic device, such as an application specific integrated circuit (ASIC). In some implementations, the microprocessor 416 is configured to carry out all or substantially all of the image processing functionality of the control logic 406. In addition, the microprocessor 416 can be capable of determining an appropriate output sequence for the display module 404 to use to generate received images. For example, the microprocessor 416 can be configured to convert image frames included in the received image data into a set of image subframes. Each image subframe can be associated with a color and a weight, and includes desired states of each of the display elements in the array of display elements 410. The microprocessor 416 also can be capable of determining the number of image subframes to display to produce a given image frame, the order in which the image subframes are to be displayed, and parameters associated with implementing the appropriate weight for each of the image subframes. These parameters may include, in various implementations, the duration for which each of the respective image subframes is to be illuminated and the intensity of such illumination. These parameters (i.e., the number of subframes, the order and timing of their output, and their weight implementation parameters for each subframe) can be collectively referred to as an “output sequence.” In some implementations, the output sequence also can include data indicative of the voltage levels output by the display drivers 412 to actuate the display elements in the array of display elements 410.

In some implementations, the control logic 406 is capable of determining light modulator state transitions associated with transitioning between consequent subframes of an image frame. The control logic 406 also can be capable of identifying light modulator state transitions in which a pair of light blocking elements of two adjacent light modulators are driven to move in opposite directions. Events in which a pair of light blocking elements of two adjacent light modulators are driven to move in opposite directions are referred to herein as opposing motion events. In some implementations, the control logic 406 can count a number of identified opposing motion events associated with a region of the image frame. In some implementations, the control logic 406 can compute a distribution density of identified opposing motion events associated with a region of the image frame. In some implementations, the control logic 406 can identify clusters of identified opposing motion events associated with a region of the image frame. The control logic 406 can further count the number of the identified clusters and/or determine their corresponding sizes. The control logic 406 is capable of obtaining an output sequence or one or more output sequence parameters based on the identified opposing motion events, and cause the image frame to be displayed according the obtained output sequence or the one or more output sequence parameters. In some implementations, the control logic 406 can adjust a voltage level in the output sequence applied to at least one light modulator. In some implementations, the control logic 406 can adjust an illumination intensity in the output sequence applied to a lamp associated with the control logic 406. In some implementations, the control logic 406 can adjust a time duration between initiating actuation of light modulators and turning on illumination light. In some implementations, the control logic 406 can adjust a number of subframes used to display the image frame.

In some implementations, the state transition logic 417 is capable of identifying opposing motion events. The state transition logic 417 can be hardware logic configured to identify the opposing motion events based on at least two temporally adjacent subframes, and provide a corresponding result to the microprocessor 416. The state transition logic 417 can be coupled to the microprocessor 416 to receive data associated with image subframes and provide a result indicative of opposing motion events to the microprocessor 416. In some implementations, the state transition logic 417 can be implemented as computer executable instructions executable by the microprocessor 416.

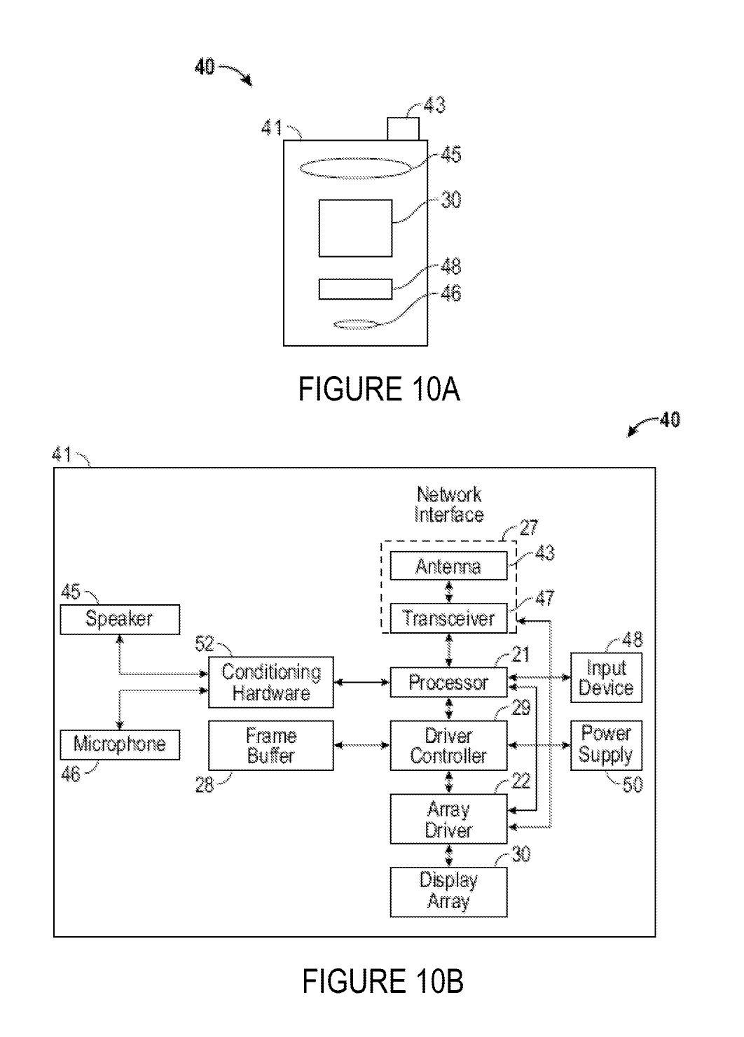

The interface chip 418 can be configured to carry out more routine operations of the display module 404. The operations may include retrieving image subframes from the frame buffer 408 and outputting control signals to the display drivers 412 and the backlight 414 in response to the retrieved image subframe and the output sequence determined by the microprocessor 416. The frame buffer 408 can be any volatile or non-volatile integrated circuit memory, such as DRAM, high-speed cache memory, or flash memory (for example, the frame buffer 408 can be similar to the frame buffer 28 shown in FIG. 10B). In some other implementations, the interface chip 418 causes the frame buffer 408 to output data signals directly to the display drivers 412. In some implementations, the interface chip 418 causes the frame buffer 408 to output data signals indicative to the state transition logic 417 for identification of opposing motion events.

In some other implementations, the functionality of the microprocessor 416 and the interface chip 418 are combined into a single logic device, which may take the form of a microprocessor, an ASIC, a field programmable gate array (FPGA) or other programmable logic device. For example, the functionality of the microprocessor 416 and the interface chip 418 can be implemented by a processor 21 shown in FIG. 10B. In some other implementations, the functionality of the microprocessor 416 and the interface chip 418 may be divided in other ways between multiple logic devices, including one or more microprocessors, ASICs, FPGAs, digital signal processors (DSPs) or other logic devices.

The array of display elements 410 can include an array of any type of display elements that can be used for image formation. In some implementations, the display elements can be EMS light modulators. In some such implementations, the display elements can be MEMS shutter-based light modulators similar to those shown in FIG. 2A or 2B. In some other implementations, the display elements can be other forms of light modulators, including liquid crystal light modulators, other types of EMS based light modulators, or light emitters, such as OLED emitters, configured for use with a time division gray scale image formation process.

The display drivers 412 can include a variety of drivers depending on the specific control matrix used to control the display elements in the array of display elements 410. In some implementations, the display drivers 412 include a plurality of scan drivers similar to the scan drivers 130, a plurality of data drivers similar to the data drivers 132, and a set of common drivers similar to the common drivers 138, all shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 404, the control matrix used to control the display elements in the array of display elements 410 is segmented into multiple regions. For example, the array of display elements 410 shown in FIG. 4 is segmented into four quadrants. A separate set of display drivers 412 is coupled to each quadrant. Dividing a display into segments in this fashion reduces the propagation time needed for signals output by the display drivers to reach the furthest display element coupled to a given driver, thereby decreasing the time needed to address the display. Such segmentation also can reduce the power requirements of the drivers employed. It also can allow for separate variation of actuation voltages applied to display elements, for example, to separately counter fluid pressure variation-based forces experienced in each quadrant resulting from opposing motion events occurring in those quadrants.

In some implementations, the display elements in the array of display elements can be utilized in a direct-view transmissive display. In direct-view transmissive displays, the display elements, such as EMS light modulators, selectively block light that originates from a backlight, which is illuminated by one or more lamps. Such display elements can be fabricated on transparent substrates, made, for example, from glass. In some implementations, the display drivers 412 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring.

The backlight 414 can include a light guide, one or more light sources (such as LEDs), and light source drivers. The light sources can include light sources of multiple primary colors, such as red, green, blue, and in some implementations white. The light source drivers are configured to individually drive the light sources to a plurality of discrete light levels to enable illumination gray scale and/or content adaptive backlight control (CABC) in the backlight. The light guide distributes the light output by light sources substantially evenly beneath the array of display elements 410. In some other implementations, for example for displays including reflective display elements, the display apparatus 400 can include a front light or other form of lighting instead of a backlight. The illumination of such alternative light sources can likewise be controlled according to illumination grayscale processes that incorporate content adaptive control features. For ease of explanation, the display processes discussed herein are described with respect to the use of a backlight. However, it would be understood by a person of ordinary skill that such processes also may be adapted for use with a front light or other similar form of display lighting.

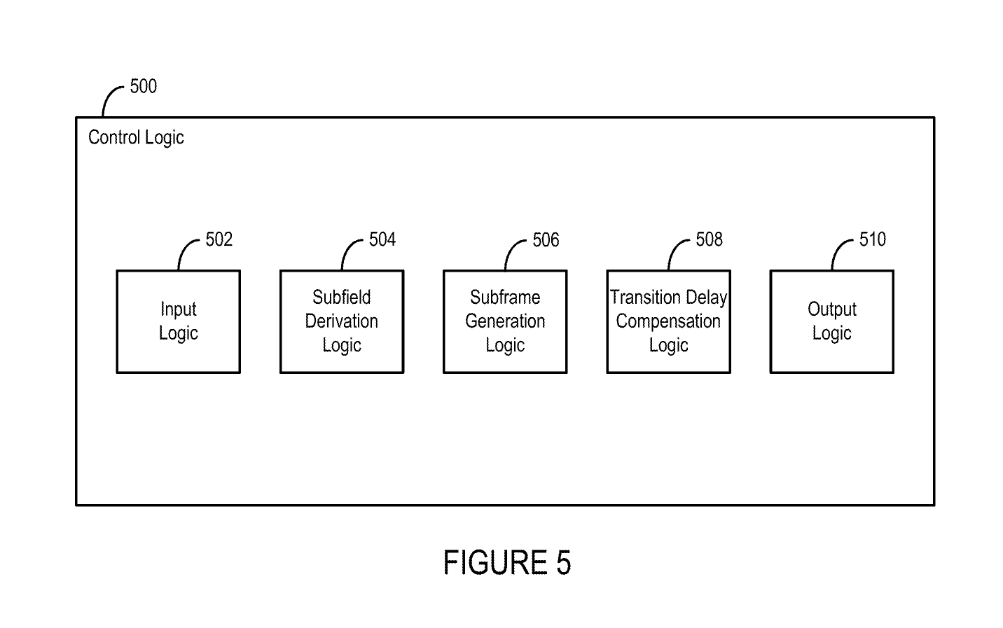

FIG. 5 shows a block diagram of example control logic 500 suitable for use as, for example, the control logic 406 in the display apparatus 400 shown in FIG. 4. More particularly, FIG. 5 shows a block diagram of functional modules, which, in some implementations, are executed by the microprocessor 416. Each functional module can be implemented as software in the form of computer executable instructions stored on a tangible computer readable medium, which can be executed by the microprocessor 416. In some implementations, one or more of the functional modules (or portions thereof) is implemented in integrated circuit logic, such as ASIC or FPGA. The control logic 500 includes input logic 502, subfield derivation logic 504, subframe generation logic 506, transition delay compensation logic 508, and output logic 510. While shown as separate functional modules in FIG. 5, in some implementations, the functionality of two or more of the modules may be combined into one or more larger, more comprehensive modules or broken down into smaller more discrete modules.

The input logic 502 is configured to receive input image data as a stream of pixel intensity values, and present the pixel intensity values to other modules within the control logic 500. The subfield derivation logic 504 can derive color subfields (such as red, green, blue, white, etc.) based on the pixel intensity values. The subframe generation logic 506 can generate subframes for each of the color subfields based on the output sequence and the pixel intensity values. The transition delay compensation logic 508 is capable of identifying opposing motion events and obtaining an output sequence or one or more output sequence parameters based on the identified opposing motion events. Processes carried out by the transition delay compensation logic 508 can be implemented by the microprocessor 416 (shown in FIG. 4), the state transition logic 417 (shown in FIG. 4), or a combination of the two. The output logic 510 can coordinate with one or more of the other logic components to determine an appropriate output sequence, and then use the output sequence to display the subframes on the display.

In some implementations, when executed by the microprocessor 416, the components of the control logic 500, along with the interface chip 418, display drivers 412, and backlight 414 (all shown in FIG. 4), function to carry out a method for generating an image on a display, such as the processes 900a and 900b shown in FIGS. 9A and 9B. The functionality of the components of the control logic 500 is described further in relation to various operations carried out as part of the processes 900a and 900b.

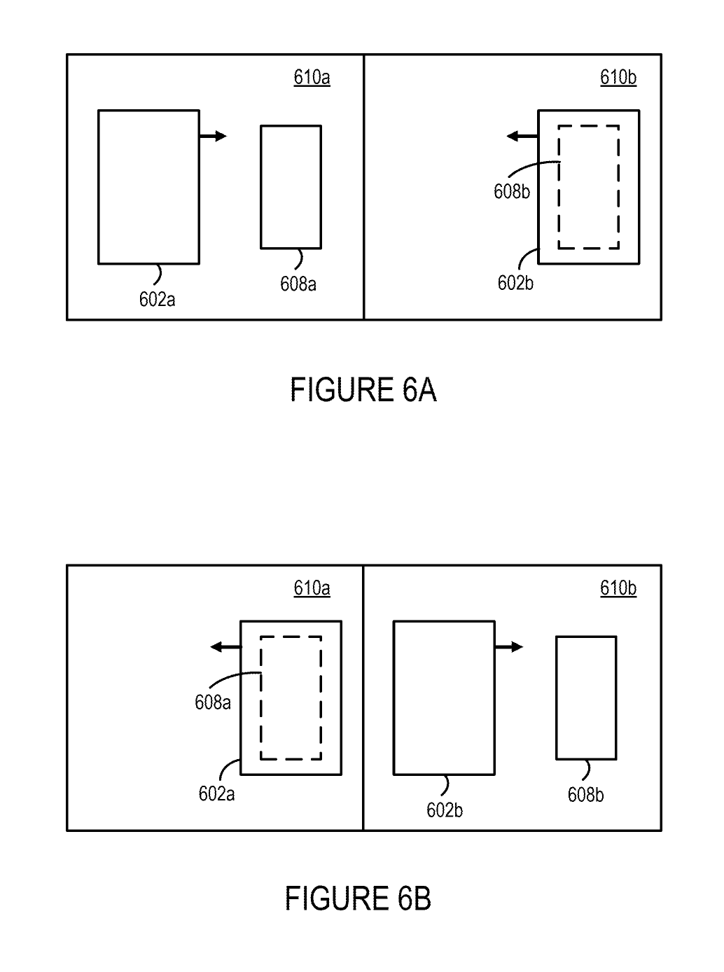

FIGS. 6A and 6B show example opposing motion events for two adjacent shutter assemblies 610a and 610b. The two adjacent shutter assemblies 610a and 610b may be two shutter assemblies similar to the shutter assembly 200 (shown in FIGS. 2A and 2B) or the shutter assemblies 302 (shown in FIG. 3). The shutter assembly 610a includes a shutter 602a configured to move relative to an aperture 608a. The shutter assembly 610b includes a shutter 602b configured to move relative to an aperture 608b.

In FIG. 6A, the shutter assembly 610a is in an open state and is to be driven to transition to a closed state. That is, the shutter 602a is currently not overlapping with the aperture 608a allowing light to pass through the aperture 608a, and is to be driven to move to a position in which it will overlap with the aperture 608a in order to block light from passing through the aperture 608a. The shutter assembly 610b is in the closed state and is to be driven to transition to the open state. That is, the shutter 602b is currently blocking light from passing through the aperture 608b, and is to be driven to move away from the aperture 608b in order to let light pass through the aperture 608b. As such, the shutters 602a and 602b are to be driven to move towards each other. The shutters 602a and 602b are immersed and surrounded by a fluid, such as the fluid 330 shown in FIG. 3. As such, fluid pressure increases between the shutters 602a and 602b as the shutters 602a and 602b move towards each other. Such increase in fluid pressure results in a first resistive force acting on and opposing the motion of the shutter 602a. The increase in fluid pressure between the shutters 602a and 602b also results in a second resistive motion acting on and opposing the motion of the shutter 602b. The resistive forces resulting from the increase in fluid pressure between the shutters 602a and 602b slow the motion of both shutters 602a and 602b.

In FIG. 6B, the shutter assembly 610a is in the closed state and is to be driven to transition to the open state. That is, the shutter 602a is currently blocking light from passing through the aperture 608a, and is to be driven to move away from the aperture 608a in order to let light pass through the aperture 608a. The shutter assembly 610b is in the open state and is to be driven to transition to the closed state. That is, the shutter 602b is currently not overlapping with the aperture 608b allowing light to pass through the aperture 608b, and is to be driven to move to a position in which it will overlap with the aperture 608b in order to block light from passing through the same aperture 608b. As such, the shutters 602a and 602b are to be driven to move away from each other. When the shutters 602a and 602b move away from each other, fluid pressure decreases between the shutters 602a and 602b creating a partial vacuum between the shutters 602a and 602b. The partial vacuum results in a first resistive force acting on and opposing the motion of the shutter 602a. The partial vacuum between the shutters 602a and 602b also results in a second resistive motion acting on and opposing the motion of the shutter 602b. The resistive forces resulting from the partial vacuum between the shutters 602a and 602b slows the motion of both shutters 602a and 602b.

The state transitions of the shutter assemblies correspond to transitioning between temporally adjacent subframes. Referring back to FIG. 4, the backlight 414 illuminates each subframe with a corresponding illumination intensity for a corresponding time duration. The microprocessor 416 determines the illumination intensity and the illumination time duration for each subframe. In various implementations, the microprocessor 416 controls when to initiate actuation of light modulators and when to turn backlight illumination on. Slower motion of the shutters due to an increase or drop in fluid pressure between neighboring shutters leads to longer state transition periods of corresponding light modulators. As a result, absent any modification to the display output sequence, shutter assemblies, such as shutter assemblies 610a and 610b, experiencing opposing motion events take longer time to transition from the closed state to the open state or vice versa than the time interval allocated in the output sequence between initiating actuation of shutter assemblies and turning backlight illumination on. State transition time delay associated with shutter assemblies can result in situations where the backlight is turned on for a subframe before all shutters are in their proper positions. Such situations can lead to image artifacts, degrading the quality of the displayed image.

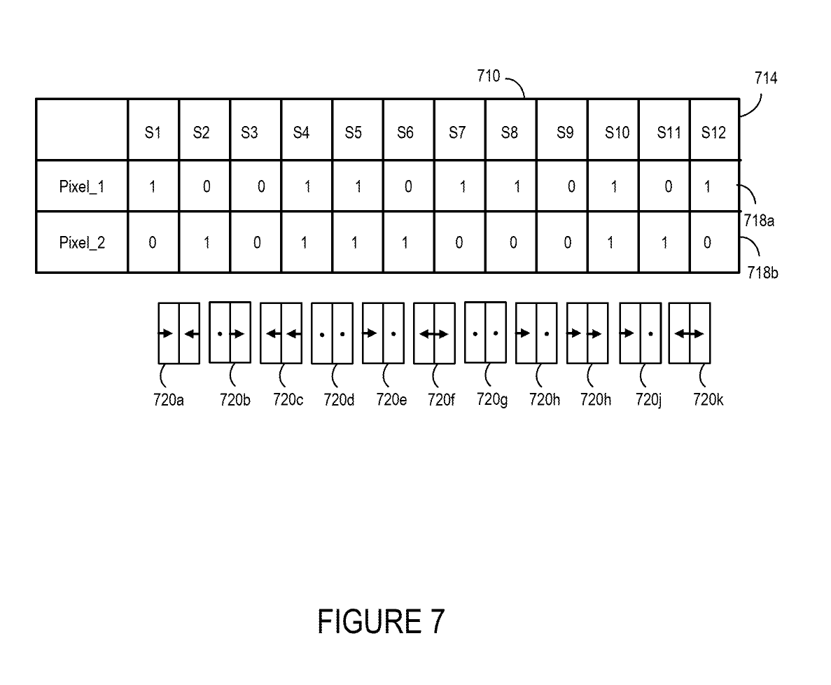

In some implementations, expected transition time delays in light modulator transitions due to opposing motion events are detected and addressed by the control logic 500. Implementations of processes for identifying opposing motion events and obtaining an output sequence based on the identified opposing motion events associated with an image frame are described with respect to FIGS. 7, 8, 9A and 9B.

FIG. 7 shows example state transitions and corresponding shutter-motion patterns associated with an example set of subframes for two adjacent light modulators. The light modulators are associated with a pair of neighboring pixels referred to as pixel_{—}1 and pixel_{—}2. A table 710 shows the states of the adjacent light modulators across an ordered list of subframes. A set of transition motions 720a-720k, also referred to either individually or collectively as transition motion(s) 720, illustrate the relative motions of the shutters in the neighboring light modulators associated with pairs of subsequent subframes.

In the table 710, the first row indicates an example of an ordered sequence of subframes 714 corresponding to a respective image frame. For example, the sequence of subframes 714 includes subframes associated with three or more subfield colors, such as red, green and blue subfields; red, green, blue, and white subfields; yellow, cyan, and magenta subfields; or some other combination of subfields used to form an image. Subframes associated with a given color subfield may be assigned different weights and may be intermingled between subframes associated with other color subfields. The order of the sequence of subframes 714 is indicative of the order in which the subframes are to be displayed and forms a portion of the output sequence executed by the output logic 510 shown in FIG. 5. In some implementations, the number of subframes used to represent a corresponding image frame depends on the number of color subfields and the number of bits used to represent image color values.

The second row of the table 710 includes a first set of light modulator states 718a associated with a first light modulator of the two neighboring light modulators across the multiple subframes in the sequences of subframes 714. The first light modulator is associated with a corresponding pixel denoted as pixel_{—}1. The third row of the table 710 includes a second set of light modulator states 718b associated with a second light modulator of the two neighboring light modulators across the multiple subframes in the sequences of subframes 714. The second light modulator is associated with a corresponding pixel denoted as pixel_{—}2. In the first and second sets of light modulator states 718a and 718b, the value 1 indicates an open state whereas the value 0 is indicative of a closed state for the corresponding subframe.

The transition motions 720a-720k are aligned with the corresponding state transitions in the table 710 of light modulators at pixel_{—}1 and pixel_{—}2. Specifically, each transition motion 720 is associated with a subframe transition between a corresponding pair of consecutive subframes. For example, the transition motions 720a, 720d, and 720h correspond to the light modulators' state transitions in pixel_{—}1 and pixel_{—}2 due to the transitions from subframe S1 to subframe S2, from subframe S4 to subframe S5, and from subframe S8 to subframe S9, respectively. Each transition motion 720 is split into two sides with the left side indicating the shutter motion at pixel_{—}1 and the right side indicating the shutter motion at pixel_{—}2. In the transition motions 720a-720k, an arrow is indicative of shutter motion either towards or away from the neighboring pixel. For example, in the transition motion 720a, the left and right arrows indicate that the shutter associated with pixel_{—}1 is to be driven towards pixel_{—}2 and, respectively, the shutter associated with pixel_{—}2 is to be driven towards pixel_{—}1. In the transition motions 720f and 720k, the left and right arrows indicate that the shutter associated with pixel_{—}1 is to be driven to move away from pixel_{—}2 and, respectively, the shutter associated with pixel_{—}2 is to be driven to move away from pixel_{—}1. The dots in the transition motions 720b, 720d, 720e, 720g, 720h, and 720j are indicative of no shutter motion. In some implementations, if at a given pixel the corresponding bit values associated with two consecutive subframes are the same, for example, both equal to 1 or both equal to 0, the light modulator state in the same pixel does not change and the corresponding shutter does not move during the subframe transition. For example, the light modulator states of pixel_{—}1 in subframes S2 and S3 are both equal to 0 resulting in no-motion at the left side of the transition motion 720b.

A person of ordinary skill in the art would appreciate that translating light modulator state transitions into corresponding transition motions such as the transition motions 720a-720k shown in FIG. 7, depends on the corresponding geometry of the shutter assemblies. Referring back to FIG. 6A, when the shutter assembly 610 is transitioning from an open state to a closed state, the shutter 602a moves towards the shutter assembly 610b. That is, the direction of the motion of the shutter 602a depends on the relative positions of the shutter 602a and the aperture 608a at the open state. For example, if the shutter assembly 610a is designed in a different way such that the relative positions of the shutter 602a and the aperture 608a are reversed at the open state, the shutter 602a would be moving away from the shutter assembly 610b in a transition from open state to closed state. If, the configuration of the shutter assembly 610b remains unchanged, in such implementations, opposing motions events would occur when the shutter assemblies 610a and 610b transition between common states (i.e., both shutter assemblies being closed transitioning to both shutter assemblies being open or vice versa). A person of ordinary skill in the art would thus appreciate that the mapping between light modulator state transitions and corresponding shutter transition motions shown in FIG. 7 may vary depending on the specific configurations of adjacent shutter assemblies.

Referring back to FIG. 7, the transition motions 720a, 720f, and 720k are indicative of opposing motion events. In particular, the transition motion 720a indicates that the shutters (for example, the shutters 602a and 602b shown in FIGS. 6A and 6B) associated with pixel_{—}1 and pixel_{—}2 are to be driven to move in opposite directions towards each other, therefore, resulting in pressure build-up between the shutters. The transition motions 720f, and 720k indicate that the shutters (for example, the shutters 602a and 602b shown in FIGS. 6A and 6B) associated with pixel_{—}1 and pixel_{—}2 are to be driven to move in opposite directions away from each other, therefore, resulting in a pressure drop between the shutters. In both cases, the shutters' motion is slowed by the increase or decrease in fluid pressure between the shutters.

In the transition motions 720b, 720e, 720h, and 720j, only one pixel among pixel_{—}1 and pixel_{—}2 is experiencing a light modulator state transition. As such, one shutter associated either with pixel_{—}1 or pixel_{—}2 is driven to move while the other shutter associated with pixel_{—}2 or, respectively, pixel_{—}1 is to stay still. In cases where one shutter is driven to move in one direction either towards or away from a neighboring shutter, while the neighboring shutter is to keep its current position, an increase or decrease in fluid pressure between the two shutters also occurs. However, such change in fluid pressure is typically less severe than that resulting from both neighboring shutters moving towards each other or away from each other. In some implementations, opposing motion events also may include the motion events described with respect to the transition motions 720b, 720e, 720h, and 720j in which only one shutter of a pair of neighboring shutter moves.

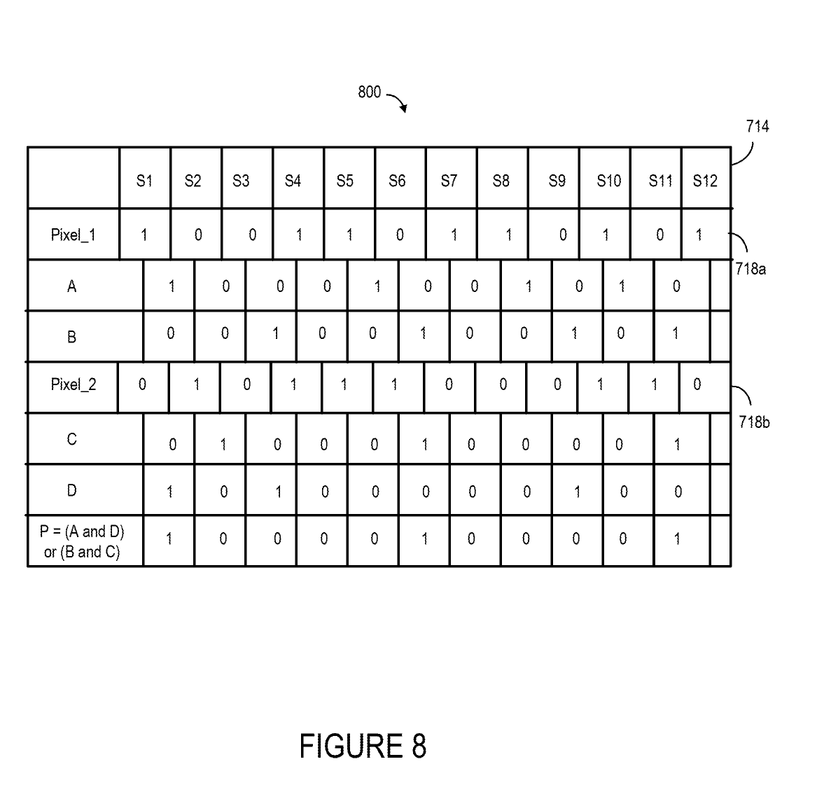

FIG. 8 shows a truth table 800 illustrating an example logic for identifying opposing motion events. The logic illustrated in the table 800 can be implemented by the transition delay compensation logic 508 shown in FIG. 5 to detect opposing motion events between subframes or across an entire image frame. The table 800 is populated using the same scenario illustrated in FIG. 7, using the sequence of subframes 714 and the light modulator state transitions 718a and 718b associated with the neighboring pixels pixel_{—}1 and pixel_{—}2.

The table 800 includes 8 rows. The first row shows the subframe sequence 714 shown in FIG. 7. The values in the second and fifth rows of the table 800 correspond, respectively, to the light modulator states 718a and 718b shown in FIG. 7. The third, fourth, sixth, and seventh rows of the table 800 indicate the presence (indicated by a 1) or absence (indicated by a 0) of four light modulator state transition types denoted as A, B, C, and D. Transition type A corresponds to a pixel_{—}1 light modulator state transition from open to closed. Transition type B corresponds to a pixel_{—}1 light modulator state transition from closed to open. Transition type C corresponds to a pixel_{—}2 light modulator state transition from open to closed. Transition type D corresponds to a pixel_{—}2 light modulator state transition from closed to open. The values in the third row of the table 800 indicate the presence or absence of an A-type transition between temporally adjacent or consecutive subframes. The values in the fourth row of the table 800 indicate the presence or absence of a B-type transition between temporally adjacent or consecutive subframes. The sixth row of the table 800 indicates the presence or absence of a C-type transition between temporally adjacent or consecutive subframes. The seventh row indicates the presence or absence of a D-type transition between temporally adjacent or consecutive subframes. The eighth row of the table 800, labeled as P, indicates whether the combination of event types associated with any given transition between temporally adjacent subframes constitutes an opposing motion event, where 1 indicates the presence of an opposing motion event and 0 indicates the absence of an opposing motion event.

Based on the illustrations provided with respect to FIGS. 6A, 6B, and 7, an opposing motion event occurs when the neighboring pixels pixel_{—}1 and pixel_{—}2 experience opposite light modulator state transitions. That is, either the light modulator of pixel_{—}1 switches from open to closed and the light modulator of pixel_{—}2 switches from closed to open (see FIG. 6A and the motion pattern 720a in FIG. 7), or the light modulator of pixel_{—}1 switches from closed to open and the light modulator of pixel_{—}2 switches from open to closed (see FIG. 6B and the motion patterns 720f and 720k in FIG. 7). Such state transitions are satisfied by the logic expression P=(A AND D) OR (B AND C) illustrated in the eighth row of table 800, where A, B, C, and D represent the state transition events described with respect to rows 3, 4, 6 and, respectively, 7 of table 800.

The logic expression also can be expressed as follows. Let X_{c} and Xₙ represent, respectively, the current and next states of the light modulator of pixel_{—}1 and Y_{c} and Yₙ represent, respectively, the current and next states of the light modulator of pixel_{—}2, then the event A is equivalent to the logic expression X_{c} AND X̅ₙ, where X̅ₙ represents the logical bar, or opposite, of Xₙ. Similarly, the event B= X̅_{c} AND Xₙ, C=Y_{c} AND Y̅ₙ, and D= Y̅_{c} AND Yₙ. Therefore, opposing motion events may be detected based on the logic expression P=( X̅_{c} AND X̅ₙ) AND ( Y̅_{c} AND Yₙ) OR ( X̅_{c} AND Xₙ) AND (Y_{c} AND Y̅ₙ). Such logic expression may be implemented using software logic, hardware logic, or a combination thereof

FIG. 9A shows a flow diagram of an example process 900a of displaying an image frame. In some implementations, the process 900a can be carried out by the control logic 500 (shown in FIG. 5). The process 900a includes obtaining an image frame (stage 905), converting the image frame into an ordered set of subframes (stage 910), identifying opposing motion events associated with the image frame (stage 915), deciding whether or not to compensate for identified opposing motion events (decision block 920), obtaining an output sequence (stage 925 or stage 930), and causing the subframes to be displayed on the display according to the obtained output sequence (stage 935 or stage 940).

Referring to FIGS. 4, 5 and 9A, the method 900a includes obtaining an image frame (stage 905). The image frame can be obtained by the input logic 502. The input logic 502 obtains an image frame to be displayed (stage 910). Typically, such image data is obtained by the input logic 502 as a stream of intensity values for the red, green, and blue components of each pixel in an image frame. The intensity values typically are received as binary numbers. The image data may be received directly from an image source, such as from an electronic storage medium incorporated into the display apparatus 400. Alternatively, it may be received from a host device 402 in which the display apparatus 400 is built.

The input logic 502, subfield derivation logic 504, and the subframe generation logic 506 convert the obtained image frame into an ordered set of subframes (stage 910). In some implementations, in converting the image frame into subframes, the subfield derivation logic 504 preprocesses the obtained image frame. For example, in some implementations, the image data includes color intensity values for more pixels or fewer pixels than are included in the display apparatus 400. In such cases, the input logic 502, the subfield derivation logic 504, or other logic incorporated into the controller 500 can scale the image data appropriately to the number of pixels included in the display apparatus 400. In some implementations, the image frame data is received having been encoded assuming a given display gamma. In some implementations, if such gamma encoding is detected, logic within the controller 500 applies a gamma correction process to adjust the pixel intensity values to be more appropriate for the gamma of the display apparatus 400. For example, image data is often encoded based on the gamma of a typical liquid crystal (LCD) display. To address this common gamma encoding, the controller 500 may store a gamma correction lookup table (LUT) from which it can quickly retrieve appropriate intensity values given a set of LCD gamma encoded pixel values. In some implementations, the LUT includes corresponding RGB intensity values having a 16 bit-per-color resolution, though other color resolutions may be used in other implementations.

In some implementations, the image frame preprocessing includes a dithering stage. In some implementations, the process of de-gamma encoding an image results in 16 bit-per-color pixel values, even though the display apparatus 400 may not be configured for displaying such a large number of bits per color. A dithering process can help distribute any quantization error associated with converting these pixel values down to a color resolution available to the display, such as 4, 5, 6, or 8 bits per color.

In some implementations, the image preprocessing can include the subfield derivation logic 504 selecting a set of color subfields for displaying the image frame. In some implementations, the selected color subfields can include frame independent contributing colors (FICCs) such as, without limitations, the colors red (R), green (G), blue (B), white (W), yellow (Y), magenta (M), cyan (C), or one or more combinations thereof. FICCs are selected independently of the image content or data associated with the image frame. In some implementations, the FICCs can include composite colors that are formed from the combination of two or more other FICCs. In some implementations, the subfield derivation logic 504 may select an additional subfield color (also referred to as the “x-channel”) whose color is a composite of at least two colors associated with at least two of the other subfields. The color selected for the x-channel can be selected based on the contents of the image frame displayed and/or one or more prior image frames. For example, the subfield generation logic 504 can select colors such as, but not limited to, white, yellow, cyan, magenta, or any other color within the display's color gamut, as the x-channel color.

Once the color subfields are selected, the subfield derivation logic 504 can generate initial pixel intensity values for each selected subfield color for all pixels. For example, the subfield derivation logic 504 can adjust the pixel intensity values for the R, G, and B subfield colors based on the pixel intensity values selected for the x-channel. For example, if selected x-channel color is white, then the subfield derivation logic 504 can select a pixel intensity value that can be equally subtracted from each of the R, G, and B color pixel intensity values and assign that value as the x-channel pixel intensity value. For example, if the pixel intensity values for a pixel were: R=100, G=200, and B=155, the subfield derivation logic 504 can subtract 100 from the pixel intensity values for each color and assign 100 as the pixel intensity value for the x-channel. The resultant adjusted pixel intensity values for the R, G, and B colors would be 0, 100, and 55, respectively. In some implementations, the subfield derivation logic 504 can subtract a fraction of the highest pixel intensity value that can be equally subtracted from each of the R, G, and B pixel intensity values. For example, continuing the above example, the subfield generation logic 504 can subtract 50 from the pixel intensity values of each color (0.5 times the highest possible value), resulting in pixel intensity values of R=50, G=150, B=105, and white=50.

The subframe generation logic 506 processes the color subfields to generate subframes. Each subframe corresponds to a particular time slot in a time division gray scale image output sequence. It includes a desired state of each display element in the display for that time slot. In each time slot, a display element can take either a non-transmissive state or one or more states that allow for varying degrees of light transmission. In some implementations, the generated subframes include a distinct state value for each display element in the array of display elements 410 shown in FIG. 4.

In some implementations, the subframe generation logic 506 uses a code word lookup table (LUT) to generate the subframes. In some implementations the code word LUT stores series of binary values referred to as code words that indicate corresponding series of display element states that result in given pixel intensity values. The value of each digit in the code word indicates a display element state (for example, light or dark) and the position of the digit in the code word represents the weight that is to be attributed to the state. In some implementations, the weights are assigned to each digit in the code word such that each digit is assigned a weight that is twice the weight of a preceding digit. In some other implementations, multiple digits of a code word may be assigned the same weight. In some other implementations, each digit is assigned a different weight, but the weights may not all increase according to a fixed pattern, digit to digit.

To generate a set of subframes, the subframe generation logic 506 obtains code words for all pixels in a color subfield. The subframe generation logic 506 can aggregate the digits in each of the respective positions in the code words for the set of pixels in the subfield together into subframes. For example, the digits in the first position of each code word for each pixel are aggregated into a first subframe. The digits in the second position of each code word for each pixel are aggregated into a second subframe, and so forth. The subframes, once generated, are stored in the frame buffer 408 shown in FIG. 4.

The transition delay compensation logic 508 identifies opposing motion events associated with pairs of temporally adjacent subframes for pairs of adjacent light modulating display elements (stage 915). In some implementations, identifying opposing motion events includes determining simultaneous light modulator state transitions based on data of consecutive subframes as described above in relation to FIGS. 6-8. In some implementations, identifying opposing motion events includes counting a number of identified opposing motion events associated with a region of the image frame. For example, the transition delay compensation logic 508 can maintain separate counts for each region of the display for which the actuation voltage can be independently adjusted. For example, for the display apparatus 400 shown in FIG. 4, the transition compensation logic can maintain separate counts for each quadrant of the display. In some implementations, the transition delay compensation logic 508 can identify a spatial distribution density of identified opposing motion events associated with a region of the image frame, for example in terms of the ratio of the number of opposing motion events identified per unit of display area. In some implementations, the transition delay compensation logic 508 can identify clusters of opposing motion events within a region of the image frame as well as the size, number, and density of such clusters.

In some implementations, the transition delay compensation logic 508 can decide whether or not to compensate for the identified opposing motion events (decision block 920). Such decision may be based on a computed count of identified opposing motion events, a computed distribution density of identified opposing motion events, determined clusters of identified opposing motion events, or any other criteria. In some implementations, the transition delay compensation logic 508 takes action to address effect(s) of opposing motion events if a number of identified opposing motion events exceeds a threshold value, such as a number in the range between about 10% and about 25% of the number of display elements in the display or a region of the image frame. In some implementations, the transition delay compensation logic 508 takes action to address effect(s) of opposing motion events if a number of clusters of opposing motion events exceeds a threshold or a size of a given cluster exceeds another threshold.

If the transition delay compensation logic 508 decides not to take any action with respect to any identified motion events (decision block 920), the output logic 510 obtains a non-compensated output sequence for displaying the image frame (stage 925), and causes the subframes to be displayed according to the obtained non-compensated output sequence (stage 935). If the transition delay compensation logic 508 decides to take action with respect to the identified opposing motion events (decision block 920), the transition delay compensation logic 508 and the output logic 510 coordinate together to obtain an opposing motion event-compensated output sequence based on the identified opposing motion events (stage 930). The output logic 510 then causes the generated subframes to be displayed according to the obtained compensated output sequence (stage 940).

In some implementations obtaining the opposing motion compensated output sequence includes adjusting one or more parameters in the output sequence. For instance, the transition delay compensation logic 508 can cause the output logic 510 to adjust an actuation voltage value in the output sequence to be applied to a light modulator. Increasing the actuation voltage applied to light modulators mitigates the effect of opposing motion events on transition motion speed by increasing the force provided by light modulator actuators, eliminating or reducing any state transition delay resulting from the opposing motion events. In some instances, the actuation voltage can be adjusted per quadrant of the display or for any segment of the array of display elements 410 configured for independent application of an actuation voltage.

In some implementations, the transition delay compensation logic 508 can cause the output logic 510 to adjust a backlight illumination duration and illumination intensity in the output sequence for a given subframe. The illumination duration is decreased to accommodate the longer amount of time it takes for the light modulator to reach its desired state. To maintain the same level of light output during the subframe, the illumination intensity of the backlight 414 is increased commensurately. The transition delay compensation logic 508 and the output logic 510 can decrease the illumination duration by adjusting a time interval between the actuation of the light modulators and the time at which the backlight 414 is illuminated for the subframe.

In some implementations, the transition delay compensation logic 508 can cause the output logic 510 to adjust the number of subframes used to display the image frame. For instance, for an image frame in which the total number of subframe transitions are determined by the transition delay compensation logic 508 to merit opposing motion event compensation exceeds a threshold, the transition delay compensation logic 508 may determine that there is not enough extra time in the subframe to fully compensate for such opposing motion events. In such cases, the transition delay compensation logic 508 and/or the output logic 510 can omit a lower weighted subframe from the output sequence. To reduce the potential for image quality degradation resulting from such a decision, the subfield derivation logic 504 and subframe generation logic 506 can recalculate the color subfields for the image frame, applying a dithering operation appropriate for the remaining number of subframes of each color, and generate new subframes based on the updated color subfields. The transition delay compensation logic 508 can then reevaluate the new set of subframes to identify opposing motion events therein. Given that the generated set of subframes is fewer in number, the transition delay compensation logic 508 and the output logic 510 have greater flexibility in adjusting the times of the remaining subframes to compensate for identified opposing motion events resulting from the transitions there between.

In some implementations, in obtaining the opposing motion compensated output sequence (stage 930), the output logic 510 receives indication(s) of output sequence parameter modifications to be made in response to identified opposing motion events from the transition delay compensation logic 508. The output logic 510 determines the output sequence, and determines one or more parameter values in the output sequence based on the indicated modifications. In some implementations, the output logic 510 stores or has access to multiple preconfigured output sequences. For example, it may store a non-compensated output sequence and one or more opposing motion event compensated output sequences, which have different parameters depending on how many subframe transitions include potentially problematic opposing motion events. The output logic 510, at the direction of the transition delay compensation logic 508, can select which output sequence to employ.

FIG. 9B shows a flow diagram of another example process 900b of displaying an image. The process 900b can be implemented, for example by the control logic 500 shown in FIG. 5. In the process 900a shown in FIG. 9A, the transition delay compensation logic 508 determines an output sequence for displaying an image frame by identifying opposing motion events occurring across all subframe transitions associated with a given image frame prior to displaying any subframes of the image frame. In contrast, in the process 900b, the transition delay compensation logic 508 identifies opposing motion events between temporally adjacent subframes as each new subframe is about to be loaded into the display, and obtains parameters of the output sequence for each subframe, one subframe at a time.

The process 900b includes obtaining data for a subframe (stage 955), identifying opposing motion events based on obtained subframe data and data of a previously loaded subframe (stage 960), deciding whether or not to compensate for identified opposing motion events (decision block 965), obtaining an output sequence parameter (stage 970 or stage 975), and causing the subframe to be displayed based on the obtained output sequence parameter (stage 980 or stage 985).

Referring to FIGS. 4, 5, and 9B, the process 900b includes the transition delay compensation logic 508 obtaining data for a subframe to be displayed (stage 955). For example, the transition delay compensation logic 508 can retrieve the subframe from the frame buffer 418. At this stage, the subframes associated with an image frame are assumed to be computed and available to the transition delay compensation logic 508. The transition delay compensation logic 508 then identifies opposing motion events based on the obtained subframe data and data corresponding to a previously loaded subframe. In some implementations, the transition delay compensation logic 508 stores the data corresponding to the previously loaded subframe in a separate dedicated frame buffer or memory. In some implementations, the transition delay compensation logic 508 obtains the data for the prior subframe from the frame buffer 418. The transition delay compensation logic 508 can identify opposing motion events (stage 960) in a similar fashion as was described above in relation to the process 900a shown in FIG. 9A.

The transition delay compensation logic 508 decides whether or not to address identified opposing motion event (decision block 965). Such decision may be based on similar criteria as described above in relation to decision block 920 shown in FIG. 9A.

If the transition delay compensation logic 508 decides not to take any action with respect to the identified motion events (decision block 965) the output logic 510 obtains non-compensated output sequence parameters for displaying the obtained subframe data (stage 970), and causes the subframe to be displayed according to the obtained non-compensated output sequence parameters (stage 980). The output sequences parameters indicate a time at which the subframe is to loaded into the display elements, the time at which the display elements should be actuated to attain the states indicated in the subframe, the time and intensity at which the backlight 414 should be illuminated for the subframe, the duration of the illumination or the time the backlight should be extinguished for the subframe, and/or the magnitudes of the voltages to be output by the display drivers 412 to cause the display elements to be appropriately actuated. If the transition delay compensation logic 508 decides to take action with respect to the identified opposing motion events (decision block 965), the transition delay compensation logic 508 and/or the output logic 510 obtain one or more opposing motion compensated output sequence parameters based on the identified opposing motion events (stage 975), and causes the subframe to be displayed according to the obtained opposing motion compensated output sequence parameters (stage 985). The control logic 500 can be implemented to then iterate back to obtain the next subframe to be displayed.

In some implementations, in contrast to the process 900a, in the process 900b, in obtaining opposing motion compensated output sequence parameters, the transition delay compensation logic 508 obtains opposing motion compensated parameters that impact the display of the subframe to be displayed without impacting the display of future subframes. For example, in some implementations, when opposing motion events are identified and addressed on a subframe-by-subframe basis as shown in FIG. 9B, dropping a subframe may not be an option or may be a less preferred option for addressing opposing motion events. Dropping a subframe can involve re-processing other subframes associated with the image frame, which may already have been displayed. As such, in such implementations, the transition delay compensation module may obtain adjusted parameters indicating the backlight 414 should be illuminated at higher intensity for a shorter duration of time to preserve the total amount of time allocated to the subframe, or indicating that the light modulators should be actuated at a higher voltage to increase the transition speed of the light modulators. In some other implementations, particularly in which lower weighted subframes are displayed at the end of the output sequence for each image frame, the transition delay compensation logic 508 may obtain opposing motion output sequence parameters that modify the display of other subframes, for example by extending the amount of time allocated to a higher-weighted subframe such that the backlight can be illuminated for a non-compensated duration and intensity, while potentially determining in advance to omit one or more not-yet-displayed lower weighted subframes.

FIGS. 10A and 10B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 10B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 10A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a plurality of light modulators; and
a controller configured to:
determine light modulator transitions associated with displaying an image frame based on at least two subframes associated with the image frame;
identify, based on the determined light modulator transitions, one or more opposing motion events in which portions of respective pairs of neighboring light modulators are to be driven in opposite directions substantially simultaneously;
obtain an output sequence parameter for displaying the image frame based on the identified one or more motion events; and
cause the image frame to be displayed according to the obtained output sequence parameter.

2. The apparatus of claim 1, wherein at least one opposing motion event includes portions of a respective pair of neighboring light modulators moving toward each other or away from each other in opposite directions substantially simultaneously.

3. The apparatus of claim 1, wherein in obtaining the output sequence parameter, the controller is further configured to adjust, based on the identified one or more opposing motion events, a voltage level indicated in the output sequence to be applied to a corresponding light modulator of the plurality of light modulators.

4. The apparatus of claim 1, wherein in obtaining the output sequence parameter, the controller is further configured to adjust, based on the identified one or more opposing motion events, an illumination intensity indicated in the output sequence to be applied to a light source associated with at least one light modulator of the plurality of light modulators.

5. The apparatus of claim 1, wherein in obtaining the output sequence parameter, the controller is further configured to adjust, based on the identified one or more opposing motion events, a time duration between initiating actuation of light modulators and turning on an illumination light.

6. The apparatus of claim 1, wherein in obtaining the output sequence parameter, the controller is further configured to adjust, based on the identified one or more opposing motion events, a number of subframes used to display the image frame.

7. The apparatus of claim 1, wherein in identifying the one or more opposing motion events, the controller is further configured to:
determine a number of opposing motion events associated with displaying a region of the image frame; and
compare the number of opposing motion events to a threshold value, the controller being further configured to obtain the output sequence parameter based on the identified one or more motion events upon determining that the number of opposing motion events is larger than or equal to the threshold value.

8. The apparatus of claim 1, wherein in identifying the one or more opposing motion events, the controller is further configured to identify a cluster of opposing motion events associated with displaying a region of the image frame, the controller being further configured to obtain the output sequence parameter based on identified cluster of opposing motion events.

9. The apparatus of claim 1, further comprising:
a display including the plurality of light modulators;
a processor capable of communicating with the display, the processor being capable of processing image frame data; and
a memory device capable of communicating with the processor.

10. The apparatus of claim 9, further comprising:
a driver circuit capable of sending at least one signal to the display, the controller being capable of sending at least a portion of the image frame data to the driver circuit.

11. The apparatus of claim 9, further comprising:
an image source module capable of sending the image frame data to the processor, wherein the image source module includes at least one of a receiver, transceiver, and transmitter.

12. The apparatus of claim 9, further comprising:
an input device capable of receiving input data and communicating the input data to the processor.

13. A non-transitory computer-readable medium including computer code instructions stored thereon, when executed by a controller, the computer code instructions:
determine light modulator transitions associated with displaying an image frame by a device including a plurality of light modulators, based on at least two subframes associated with the image frame;
identify, based on the determined light modulator transitions, one or more opposing motion events in which portions of respective pairs of neighboring light modulators are to be driven in opposite directions simultaneously;
obtain an output sequence parameter for displaying the image frame based on the identified one or more motion events; and
cause the image frame to be displayed according to the obtained output sequence parameter.

14. The non-transitory computer-readable medium of claim 13, wherein at least one opposing motion event includes portions of a respective pair of neighboring light modulators moving toward each other or away from each other in opposite directions simultaneously.

15. The non-transitory computer-readable medium of claim 13, wherein obtaining the output sequence parameter includes adjusting, based on the identified one or more opposing motion events, a voltage level indicated in the output sequence to be applied to a corresponding light modulator of the plurality of light modulators.

16. The non-transitory computer-readable medium of claim 13, wherein obtaining the output sequence parameter includes adjusting, based on the identified one or more opposing motion events, an illumination intensity indicated in the output sequence to be applied to a light source associated with at least one light modulator of the plurality of light modulators.

17. The non-transitory computer-readable medium of claim 13, wherein obtaining the output sequence parameter includes adjusting, based on the identified one or more opposing motion events, a time duration between initiating actuation of light modulators and turning on an illumination light.

18. The non-transitory computer-readable medium of claim 13, wherein obtaining the output sequence parameter includes adjusting, based on the identified one or more opposing motion events, a number of subframes used to display the image frame.

19. The non-transitory computer-readable medium of claim 13, wherein identifying the one or more opposing motion events includes:
determining a number of opposing motion events associated with displaying a region of the image frame;
comparing the number of opposing motion events to a threshold value; and
obtaining the output sequence parameter upon determining that the number of opposing motion events is larger than or equal to the threshold value.

20. The non-transitory computer-readable medium of claim 13, wherein identifying the one or more opposing motion events, includes identifying a cluster of opposing motion events associated with displaying a region of the image frame, obtaining the output sequence parameter being further based on the identified cluster of opposing motion events.
